(19) United States
(12) Patent Application Publication
(10) Pub. No.: US 2026/0004769 A1
(43) Pub. Date: Jan. 1, 2026

(54) METHOD FOR GENERATING AUDIO BASED ON LARGE MODEL, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Liqiang ZHANG, Beijing (CN); Zhe PENG, Beijing (CN); Xuexin XU, Beijing (CN); Tao SUN, Beijing (CN); Lei JIA, Beijing (CN)

(73) Assignee: BEIJING BAIDU NETCOM SCIENCE TECHNOLOGY CO., LTD., Beijing (CN)

(21) Appl. No.: 19/319,100

(22) Filed: Sep. 4, 2025

(30) Foreign Application Priority Data
Mar. 14, 2025 (CN) 202510308014.8

(51) Int. Cl. G10L 13/08; G06N 3/0455; G10L 19/00

(52) U.S. Cl. CPC G10L 13/08; G06N 3/0455; G10L 19/00

(57) ABSTRACT

The present application provides a method for generating audio based on large model, an electronic device, and a storage medium, which relates to a technical field of artificial intelligence such as an audio synthesis and a large model. A specific implementation includes: obtaining a character that is generated in real time during a process of generating a text using a large model; obtaining an audio feature of each audio unit of the character sequentially by using a pre-trained audio generation model based on the character; the audio feature of the audio unit is a discretized audio feature, and the character includes audio features of a plurality of different audio units; synthesizing a corresponding audio by using a pre-trained vocoder based on the audio feature of each audio unit.

The present application claims the priority of Chinese Patent Application No. 202510308014.8, filed on Mar. 14, 2025, with the title of “METHOD FOR GENERATING AUDIO BASED ON LARGE MODEL, APPARATUS, ELECTRONIC DEVICE, AND STORAGE MEDIUM”. The disclosure of the above application is incorporated herein by reference in its entirety.

### FIELD OF THE DISCLOSURE

The present application relates to the field of computer technology, specifically to the field of artificial intelligence technology such as audio synthesis and large models, particularly to a method for generating audio based on large model, an electronic device, and a storage medium.

### BACKGROUND OF THE DISCLOSURE

With the rapid development of artificial intelligence technology, voice interaction devices such as smart speakers, smart TVs, and in-vehicle voice systems have become deeply integrated into people's daily lives, and speech synthesis technology has also made significant progress. Voice interaction based on these technologies has become one of the most popular interaction methods due to its naturalness and convenience of the voice interaction.

In the existing speech synthesis technology, when performing a speech synthesis, an entire text segment needs to be input into a speech synthesis system before a streaming synthesis can be performed.

### SUMMARY OF THE DISCLOSURE

The present application provides a method for generating audio based on large model, an electronic device, and a storage medium.

According to one aspect of the present application, a method for generating audio based on large model is provided, including:
obtaining a character that is generated in real time during a process of generating a text using a large model;
obtaining an audio feature of each audio unit of the character sequentially by using a pre-trained audio generation model based on the character; the audio feature of the audio unit is a discretized audio feature, and the character includes audio features of a plurality of different audio units;
synthesizing a corresponding audio by using a pre-trained vocoder based on the audio feature of each audio unit.

According to another aspect of the present application, there is provided an electronic device, including:
at least one processor; and
a memory communicatively connected with the at least one processor;
wherein the memory stores instructions executable by the at least one processor, and the instructions are executed by the at least one processor to enable the at least one processor to perform a method for generating audio based on large model, wherein the method for generating audio based on large model includes:
obtaining a character that is generated in real time during a process of generating a text using a large model;
obtaining an audio feature of each audio unit of the character sequentially by using a pre-trained audio generation model based on the character; the audio feature of the audio unit is a discretized audio feature, and the character includes audio features of a plurality of different audio units;
synthesizing a corresponding audio by using a pre-trained vocoder based on the audio feature of each audio unit.

According to yet another aspect of the present application, there is provided a non-transitory computer readable storage medium with computer instructions stored thereon, wherein the computer instructions are used for causing a method for generating audio based on large model, wherein the method for generating audio based on large model includes:
obtaining a character that is generated in real time during a process of generating a text using a large model;
obtaining an audio feature of each audio unit of the character sequentially by using a pre-trained audio generation model based on the character; the audio feature of the audio unit is a discretized audio feature, and the character includes audio features of a plurality of different audio units;
synthesizing a corresponding audio by using a pre-trained vocoder based on the audio feature of each audio unit.

It should be understood that a content described in this section is not intended to identify a key or an essential feature of embodiments of the present application, nor is it intended to limit the scope of the present application. Other features of the present application will become readily apparent through the following specification.

### BRIEF DESCRIPTION OF DRAWINGS

The drawings are used to better understand a solution and do not constitute a limitation of the present application. In the drawings:

FIG. 1 is a schematic diagram according to a first embodiment of the present application;

FIG. 2 is a schematic diagram according to a second embodiment of the present application;

FIG. 3 is a structural schematic diagram of an audio generation model provided in the present embodiment;

FIG. 4 is a schematic diagram according to a third embodiment of the present application;

FIG. 5 is a schematic diagram according to a fourth embodiment of the present application;

FIG. 6 is a block diagram of an electronic device for implementing an embodiment of the present application.

### DETAILED DESCRIPTION OF PREFERRED EMBODIMENTS

The following describes exemplary embodiments of the present application in conjunction with the drawings, which include various details of the embodiments to aid understanding, and should be considered merely exemplary. Therefore, those skilled in the art should recognize that various changes and modifications can be made to the embodiments described herein without departing from a scope and a spirit of the present application. Similarly, for clarity and conciseness, descriptions of known functions and structures are omitted.

Obviously, the described embodiments are some but not all embodiments of the present application. All other embodiments obtained by those skilled in the art without a creative effort based on the embodiments in the present application fall within a protection scope of the present application.

It should be noted that a terminal device involved in the embodiments of the present application may include but is not limited to a mobile phone, a Personal Digital Assistant (PDA), a wireless handheld device, a Tablet Computer and other smart devices; a display device may include but is not limited to a personal computer, a television and other devices with a display function.

Additionally, the term “and/or” in this document is merely a description of an associative relationship of associated objects, indicating that three relationships may exist. For example, A and/or B may indicate: A exists alone, both A and B exist, or B exists alone. Furthermore, the character “/” in this document generally indicates an “or” relationship between the associated objects before and after the character.

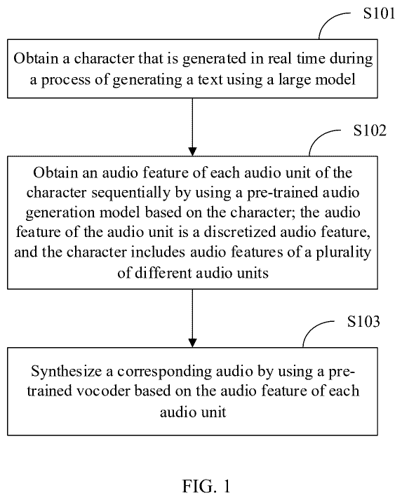

FIG. 1 is a schematic diagram according to a first embodiment of the present application.

As shown in FIG. 1, the present embodiment provides a method for generating audio, which specifically includes the following steps:
S101: Obtaining a character that is generated in real time during a process of generating a text using the large model;
S102: Obtaining an audio feature of each audio unit of the character sequentially by using a pre-trained audio generation model based on the character; the audio feature of the audio unit is a discretized audio feature, and the character includes audio features of a plurality of different audio units;
S103: Synthesizing a corresponding audio by using a pre-trained vocoder based on the audio feature of each audio unit.

An execution subject of the method for generating audio in the present embodiment may be an apparatus for generating audio, and the apparatus may be an electronic entity or an application integrated with software.

In the present embodiment, the method for generating audio is used in combination with a large model. The large model here may refer to a generative large model. Typically, during the text generation process, the large model outputs a text character-by-character through an autoregressive decoding in a streaming manner. If a traditional method for generating audio is used, the audio generation could only begin after the large model has generated an entire text passage, resulting in a significant latency in the audio generation.

In the present embodiment, a character that is generated in real time can be obtained during the process of generating the text using the large model, which can be understood as obtaining the character that is generated in real time at a character granularity. For example, when the large model generates a text character-by-character, and each time a character is generated, the generated character is obtained. Then, further, the audio generation model is used to sequentially obtain the audio features of each audio unit of the character. For a character, the character may include audio features of a plurality of audio units with a sequential relationship, and the audio generation model may sequentially obtain the audio feature of each audio unit of the character. When the vocoder synthesizes an audio, the vocoder synthesizes based on the granularity of the audio unit. As the audio generation model obtains the audio feature of each audio unit, the vocoder can synthesize a corresponding audio for the audio unit, achieving an audio synthesis for a character at a minimum granularity, i.e., the audio unit. This can reduce the latency of the audio synthesis and improve the naturalness and the fluency of the synthesized audio, thereby enhancing a user experience of a voice interaction based on the large model.

In the present embodiment, unlike a mel-spectrogram audio feature in the traditional technology, the audio feature of an audio unit obtained by the audio generation model is specifically a discretized feature of an audio, while the mel-spectrogram audio feature is a continuous feature of an audio. Typically, one character can correspond to audio features of a plurality of different audio units; and the audio features of the plurality of different audio units included in one character also have a certain sequential relationship.

When the technology of this embodiment is specifically implemented, it can be considered as a streaming reading of the character generated by the large model. For example, it can be reading the character generated by the large model at a character granularity; and using the audio generation model to sequentially obtain an audio feature of each audio unit of the character in a streaming manner; and then sequentially synthesizing a corresponding audio based on the audio feature of each audio unit, achieving a streaming output of an audio. In this way, the latency of audio generation can be effectively shortened and the efficiency of voice interaction based on the large model can be improved.

The method for generating audio of the present embodiment, through adopting the above technical solution, can effectively reduce the latency of generating an audio for a character output by the large model, and improve the naturalness and the fluency of the synthesized audio, thereby enhancing the user experience of voice interaction based on large model.

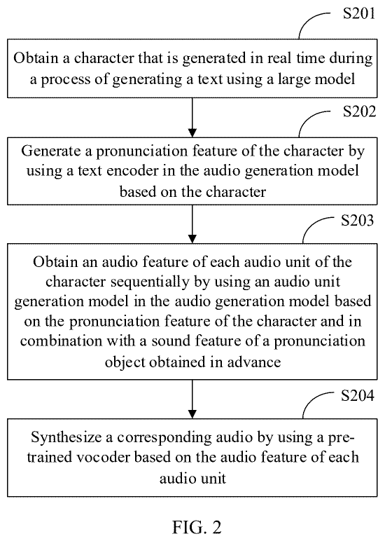

FIG. 2 is a schematic diagram according to a second embodiment of the present application. As shown in FIG. 2, the method for generating audio of the present embodiment, based on the technical solution shown in FIG. 1 above, further describes the technical solution of the present application in more detail. As shown in FIG. 2, the method for generating audio of the present embodiment specifically includes the following steps:
S201: Obtaining a character that is generated in real time during a process of generating a text using a large model;
S202: Generating a pronunciation feature of the character by using a text encoder in the audio generation model based on the character;

The text encoder in the audio generation model of the present embodiment may be called a text-encoder. In a specific use, the character generated in real time by the large model is input into the text-encoder, and the text-encoder can encode the character using a self-attention mechanism based on the character to generate a corresponding pronunciation feature. The pronunciation feature of the character in the present embodiment is used to identify how the character should be pronounced, for example, the pronunciation feature may include at least one of a phoneme, a prosody, and a pitch feature of the character. The pronunciation feature is very rich and can accurately and efficiently identify a pronunciation of the character.

Optionally, in an embodiment of the present application, some characters are polyphonic, and without a context, a pronunciation feature of these characters can easily be generated incorrectly. In order to improve the accuracy of the generated pronunciation feature of the character, when processing a first packet of a character, the text encoder needs to accumulate a preset number of characters before processing the characters sequentially. The preset number of characters in the present embodiment refers to the size of the first packet. Specifically, the size of the first packet can be set based on an experience or a requirement. For example, the size can include 5 characters, 4 characters, or other numbers of characters, which is not limited here.

Therefore, in a specific implementation of the step S202, when the text encoder first starts processing a character generated by the large model, the text encoder can check whether the number of characters input in the first packet is greater than or equal to a predetermined quantity. If the text encoder determines that the number of characters input in the first packet is greater than or equal to the predetermined quantity, the step S202 can be performed to process characters one by one according to a streaming acquisition order from front to back.

That is, for the first packet of a character generated by the large model, after accumulating the preset number of characters, the text encoder can encode each character sequentially according to the acquisition order from front to back, and generate a pronunciation feature corresponding to each character, which can effectively improve an accuracy of the pronunciation feature generated for the first packet of the character. For a non-first packet character, the character generated in real time by the large model can be obtained one by one, and the text encoder can generate a pronunciation feature for the character, which can effectively reduce the latency and improve the efficiency of generating the pronunciation feature for the character.
S203: Obtaining an audio feature of each audio unit of the character sequentially by using an audio unit generation model in the audio generation model based on the pronunciation feature of the character and in combination with a sound feature of a pronunciation object obtained in advance;
S204: Synthesizing a corresponding audio by using a pre-trained vocoder based on the audio feature of each audio unit.

The pronunciation object of the present embodiment may refer to the pronunciation object used in the audio to be generated. The pronunciation object may be any person, cartoon character, or animal in the real world, etc., and is not limited here. For example, in actual applications, users can select any person or animal according to their needs or personal preferences, and perform voice broadcasting on the text generated by the large model.

In the present embodiment, the sound feature of the pronunciation object may include at least one of a timbre feature and a prosody feature of the pronunciation object. The prosody feature of the pronunciation object can identify a pronunciation style of the pronunciation object. Furthermore, the sound feature of the pronunciation object may also include an emotional feature used by the pronunciation object to identify an emotion adopted by the pronunciation object.

Optionally, in the present embodiment, during a specific use, sound features of a plurality of different pronunciation objects can be collected in advance for a user to choose from. Alternatively, an audio of a pronunciation object can be collected in real-time and input into the audio unit generation model, and the audio unit generation model then extracts the sound feature of the pronunciation object from the audio in real-time.

In the present embodiment, taking the audio generation model includes two main parts—the text encoder and an audio unit generation module—as an example, in a practical application, the audio generation model can also adopt other structures, and is not limited here.

Further optionally, in an embodiment of the present application, the step S203 may specifically include the following steps when implemented:
(1) Generating a synthesized audio feature of the character by using an audio unit encoder in the audio unit generation model based on the pronunciation feature of the character and in combination with the sound feature of the pronunciation object obtained in advance;
(2) Obtaining an audio feature of each audio unit of the character sequentially by using an audio unit decoder in the audio unit generation model based on the synthesized audio feature of the character.

In the present embodiment, the audio generation model may further include an audio unit encoder and an audio unit decoder. The pronunciation feature of the character and the sound feature of the pronunciation object are input into the audio unit encoder, and the audio unit encoder performs an encoding using a self-attention mechanism based on the two parts of input information to generate a synthesized audio feature of the character. Then the audio unit decoder performs a decoding using a cross-attention mechanism on the synthesized audio feature to sequentially obtain the audio feature of each audio unit included in the character.

The sound feature of the pronunciation object here may include at least one of a timbre of the pronunciation object and a prosody of the pronunciation object.

In the present embodiment, after generating the audio feature of the audio unit of the character, the audio generation model generates a preset separator to indicate that a decoding of a previous character has been completed, which facilitates a decoding alignment. In the present embodiment, when the audio unit decoder decodes the preset separator, the audio unit decoder does not input the preset separator into the vocoder for generating an audio. The preset separator in the present embodiment may be any preset placeholder, with no specific form limitation.

For example, in the present embodiment, when implementing the step (2), the audio unit decoder in the audio unit generation model can first be used to sequentially decode an identifier of each audio unit of the character based on the synthesized audio feature of the character; then a corresponding audio feature of the audio unit is obtained based on the identifier of each the audio unit and a pre-created audio unit database. Through this approach, the audio feature of each audio unit of the character can be obtained accurately and efficiently.

The audio unit database may include identifiers of a plurality of audio units and the audio feature of each audio unit. When an audio unit identifier is obtained, the corresponding audio feature of the audio unit can be retrieved from the audio unit database.

In the present embodiment, the audio unit database can be created and stored in advance. Specifically, a plurality of segments of an original audio can be collected, where each original audio segment can be an audio from any pronunciation object. For any original audio, the dimension of the original audio is reduced through a downsampling encoder. For example, 1 second of an audio can be downsampled to 25 dimensions, then processed through a Vector Quantized Variational Auto Encoder (VQ-VAE), finally becoming an audio feature of 25 audio units, which means 1 second of an audio corresponds to an audio feature of 25 audio units, with each audio unit's audio feature having a length of 40 milliseconds. In the present embodiment, an audio unit may be simply called a token. Finally, the identifier of each collected audio unit and the audio feature of the audio unit are stored together in the audio unit database. The above downsampling encoder method in the present embodiment is just an example. In a practical application, other methods or other downsampling rates can be used, which is not limited here.

The audio unit decoder in the present embodiment, during a decoding process, can be considered as a process of upsampling to restore the audio. Through quantization, the audio becomes a discretized audio feature of an audio unit. This process will produce a loss, so in the present embodiment, a sound feature such as a timbre feature of the pronunciation object can be added in the vocoder. Then the vocoder synthesizes the corresponding audio of the audio unit based on both the timbre feature of the pronunciation object and the audio feature of the audio unit, which can effectively improve an audio quality and a restoration of the generated audio.

For example, FIG. 3 is a structural schematic diagram of an audio generation model provided in the present embodiment. As shown in FIG. 3, the audio generation model takes as an example including three parts: a text encoder, an audio unit encoder, and an audio unit decoder. The text encoder, the audio unit encoder, and the audio unit decoder all use a transformer framework for implementation.

The text encoder can be pre-trained and fixed in the audio generation model. Then training data is used to train the audio unit encoder and the audio unit decoder together in the audio generation model.

During the training of the text encoder, a pronunciation feature corresponding to each character can be collected based on a relevant technology implemented in an existing front-end. The text encoder is then trained based on each character and a corresponding pronunciation feature of the character.

When jointly training the audio unit encoder and the audio unit decoder, an audio feature of an audio unit included in each character can be manually annotated, or an existing tool can be used to automatically obtain the audio feature of the audio unit included in each character; Then the audio unit encoder and the audio unit decoder are jointly trained based on the audio feature of the audio unit included in each character.

The technical solution of the present embodiment can achieve a streaming acquisition of a character generated in real time from the large model, a streaming acquisition of an audio feature of an audio unit for each character, and a streaming synthesis of the audio feature of each audio unit, which can effectively reduce a latency of an audio synthesis and improve a naturalness and a fluency of a synthesized audio, thereby enhancing a user experience of a voice interaction based on the large model.

Compared with traditional technology, the method for generating audio of the present embodiment does not rely on a whole sentence input and does not require front-end processing. The method for generating audio can synthesize an audio for a character generated by the large model in real time, effectively reducing an audio synthesis latency and meeting a real-time interaction requirement.

In the present embodiment, a preset quantity of a character for a first packet processing by the text encoder can also be set, which can effectively reduce an occurrence rate of a polyphonic character and a prosody error, making a quality of a synthesized audio reach a level of a traditional whole sentence input system, while effectively improving the naturalness and an accuracy of the synthesized audio.

In the present embodiment, by adding a separator prediction after the audio unit decoder completes decoding an audio feature of a plurality of audio units for each character, the stability of an attention mechanism of the audio unit decoder can be effectively improved, thereby improving the accuracy of decoding.

The method for generating audio of the present embodiment can seamlessly integrate with a large model, effectively reducing an interaction latency. In a real-time interaction scenario such as customer service and Q&A, the method for generating audio provides a user with a more fluid and a more natural voice interaction experience, further enhancing market competitiveness.

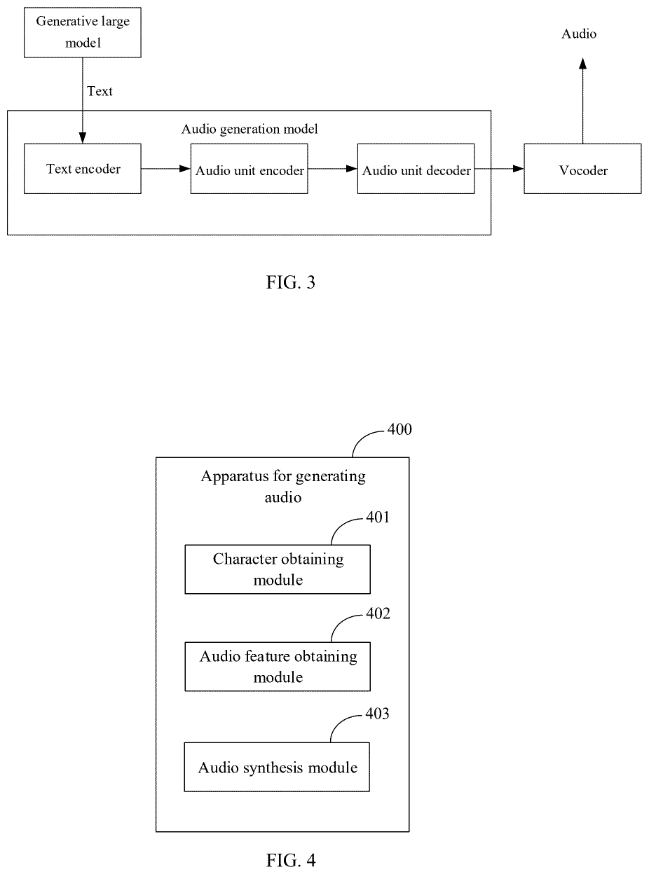

FIG. 4 is a schematic diagram according to a third embodiment of the present application.

As shown in FIG. 4, an apparatus 400 for generating audio of the present embodiment includes:
a character obtaining module 401, configured to obtain a character that is generated in real time during a process of generating a text using the large model;
an audio feature obtaining module 402, configured to an audio feature of each audio unit of the character sequentially by using a pre-trained audio generation model based on the character; the audio feature of the audio unit is a discretized audio feature, and the character includes audio features of a plurality of different audio units;
an audio synthesis module 403, configured to synthesize a corresponding audio by using a pre-trained vocoder based on the audio feature of each audio unit.

The apparatus 400 for generating audio of the present embodiment implements the same working principle and achieves the same technical effect as the above-mentioned method embodiments through the use of these modules. For details, a reference can be made to the descriptions in the above-mentioned method embodiments, which will not be repeated here.

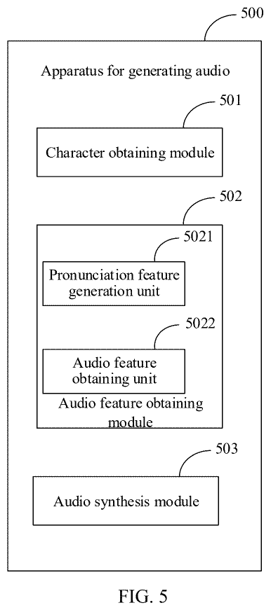

FIG. 5 is a schematic diagram according to a fourth embodiment of the present application.

As shown in FIG. 5, an apparatus 500 for generating audio of the present embodiment, based on the technical solution of the embodiment shown in FIG. 4, further describes the technical solution of the present application in more detail. As shown in FIG. 5, the apparatus 500 for generating audio of the present embodiment includes the same-named and same-functioned modules as shown in FIG. 4: a character obtaining module 501, an audio feature obtaining module 502, and an audio synthesis module 503.

As shown in FIG. 5, the audio feature obtaining module 502 includes:
a pronunciation feature generation unit 5021, configured to generate a pronunciation feature of the character by using a text encoder in the audio generation model based on the character;
an audio feature obtaining unit 5022, configured to obtain an audio feature of each audio unit of the character sequentially by using an audio unit generation model in the audio generation model based on the pronunciation feature of the character and in combination with a sound feature of a pronunciation object obtained in advance.

Further optionally, in an embodiment of the present application, the pronunciation feature generation unit 5021 is configured to generate the pronunciation feature of the character by using the text encoder based on the character in response to determining that a quantity of a character input in a first packet is greater than or equal to a predetermined quantity.

Further optionally, in an embodiment of the present application, the audio feature obtaining unit 5022 is configured to:
generate a synthesized audio feature of the character by using an audio unit encoder in the audio unit generation model based on the pronunciation feature of the character and in combination with the sound feature of the pronunciation object obtained in advance;
obtain an audio feature of each audio unit of the character sequentially by using an audio unit decoder in the audio unit generation model based on the synthesized audio feature of the character.

Further optionally, in an embodiment of the present application, the audio feature obtaining unit 5022 is configured to:
decode an identifier of each audio unit of the character sequentially by using the audio unit decoder in the audio unit generation model based on the synthesized audio feature of the character;
obtain a corresponding audio feature of the audio unit based on the identifier of each the audio unit and a pre-created audio unit database.

Further optionally, in an embodiment of the present application, the pronunciation feature of the character includes at least one of a phoneme, a prosody and a pitch.

Further optionally, in an embodiment of the present application, the audio feature obtaining unit 5022 is further configured to:
generate a preset separator by using the audio generation model after generating the audio feature of the audio unit of the character.

Further optionally, in an embodiment of the present application, the audio synthesis module 503 is configured to:
synthesize a corresponding audio by using the vocoder based on the audio feature of each the audio unit and in combination with the sound feature of the pronunciation object.

The apparatus 500 for generating audio of the present embodiment implements the same working principle and achieves the same technical effect as the above-mentioned method embodiments through the use of these modules. For details, a reference can be made to the descriptions in the above-mentioned method embodiments, which will not be repeated here.

According to embodiments of the present application, the present application also provides an electronic device, a readable storage medium, and a computer program product.

In the technical solutions of the present application, the acquisition, storage, and application of a user personal information comply with a relevant law and a relevant regulation, and do not violate a public order and a good moral.

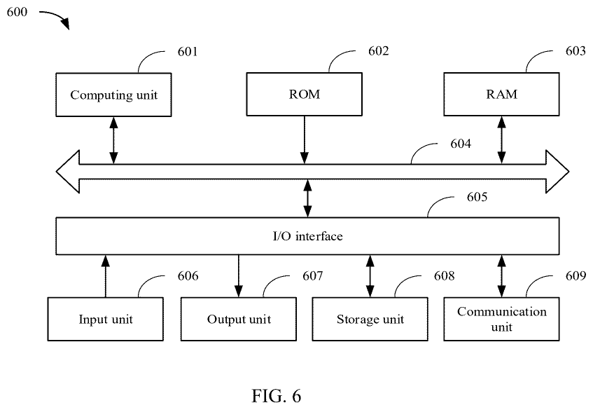

FIG. 6 shows a schematic block diagram of an example electronic device 600 that can be used to implement an embodiment of the present application. The electronic device is intended to represent various forms of a digital computer, such as a laptop, a desktop computer, a workstation, a personal digital assistant, a server, a blade server, a mainframe computer, and other suitable computers. The electronic device can also represent various forms of a mobile device, such as a personal digital processor, a cellular phone, a smartphone, a wearable device, and other similar computing devices. The components shown here, their connections and relationships, and their functions are meant merely as examples, and are not intended to limit an implementation of the present application described and/or claimed in this document.

As shown in FIG. 6, a device 600 includes a computing unit 601, which can execute various appropriate actions and processing according to a computer program stored in a Read-Only Memory (ROM) 602 or a computer program loaded from a storage unit 608 to a Random Access Memory (RAM) 603. Various programs and data required for an operation of the device 600 can also be stored in the RAM 603. The computing unit 601, the ROM 602, and the RAM 603 are connected to each other via a bus 604. An Input/Output (I/O) interface 605 is also connected to the bus 604.

A plurality of components in the device 600 are connected to the I/O interface 605, including: an input unit 606, such as a keyboard, a mouse, etc.; an output unit 607, such as various types of a display, a speaker, etc.; a storage unit 608, such as a magnetic disk, an optical disk, etc.; and a communication unit 609, such as a network card, a modem, a wireless communication transceiver, etc. The communication unit 609 allows the device 600 to exchange an information/a data with another device through a computer network such as the Internet and/or various telecommunication networks.

The computing unit 601 can be various general-purpose and/or specialized processing components with a processing and a computing capability. Some examples of the computing unit 601 include but are not limited to a Central Processing Unit (CPU), a Graphics Processing Unit (GPU), various specialized Artificial Intelligence (AI) computing chips, various computing units running a machine learning model algorithm, a Digital Signal Processor (DSP), and any appropriate processor, controller, or microcontroller. The computing unit 601 executes the various methods and processes described above, such as the methods of the present application. For example, in some embodiments, the above-mentioned methods of the present application can be implemented as a computer software program that is tangibly embodied in a machine-readable medium, such as the storage unit 608. In some embodiments, a part or all of the computer program can be loaded and/or installed onto the device 600 via the ROM 602 and/or the communication unit 609. When the computer program is loaded into the RAM 603 and executed by the computing unit 601, one or more steps of the above-described methods of the present application can be executed. Alternatively, in other embodiments, the computing unit 601 can be configured to execute the above-mentioned methods of the present application through any other appropriate means (for example, through a firmware).

Various implementations of the systems and techniques described in this document can be realized in a digital electronic circuitry, an integrated circuitry, a Field Programmable Gate Array (FPGA), an Application Specific Integrated Circuit (ASIC), an Application Specific Standard Product (ASSP), a System on Chip (SoC), a Complex Programmable Logic Device (CPLD), a computer hardware, a firmware, a software, and/or combinations of them. These various implementations can include an implementation in one or more computer programs that are executable and/or interpretable on a programmable system including at least one programmable processor, which can be a special or a general purpose programmable processor, coupled to receive a data and an instruction from, and to transmit a data and an instruction to, a storage system, at least one input device, and at least one output device.

A program code for implementing the methods of the present application can be written in any combination of one or more programming languages. These program codes can be provided to a processor or a controller of a general-purpose computer, a special-purpose computer, or other programmable data processing apparatus, such that the program codes, when executed by the processor or the controller, cause the functions/operations specified in the flowcharts and/or the block diagrams to be implemented. The program code can execute entirely on a machine, partly on the machine, as a standalone software package partly on the machine and partly on a remote machine, or entirely on the remote machine or a server.

In the context of the present application, a machine-readable medium can be a tangible medium that can contain or store a program for use by or in connection with an instruction execution system, an apparatus, or a device. The machine-readable medium can be a machine-readable signal medium or a machine-readable storage medium. The machine-readable medium can include, but is not limited to, an electronic, a magnetic, an optical, an electromagnetic, an infrared, or a semiconductor system, an apparatus, or a device, or any suitable combination thereof. More specific examples of a machine-readable storage medium would include an electrical connection based on one or more wires, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

To provide an interaction with a user, the systems and techniques described here can be implemented on a computer having: a display device (e.g., a CRT (Cathode Ray Tube) or an LCD (Liquid Crystal Display) monitor) for displaying an information to the user; and a keyboard and a pointing device (e.g., a mouse or a trackball) by which the user can provide an input to the computer. Other kinds of a device can be used to provide an interaction with a user; for example, a feedback provided to the user can be any form of a sensory feedback (e.g., a visual feedback, an auditory feedback, or a tactile feedback); and an input from the user can be received in any form, including an acoustic input, a speech input, or a tactile input.

The systems and techniques described here can be implemented in a computing system that includes a back-end component (e.g., as a data server), or that includes a middleware component (e.g., an application server), or that includes a front-end component (e.g., a user computer having a graphical user interface or a web browser through which a user can interact with an implementation of the systems and techniques described here), or any combination of such a back-end component, a middleware component, or a front-end component. The components of the system can be interconnected by any form or medium of a digital data communication (e.g., a communication network). Examples of a communication network include a Local Area Network (LAN), a Wide Area Network (WAN), and the Internet.

A computer system can include a client and a server. A client and a server are generally remote from each other and typically interact through a communication network. A relationship of a client and a server arises by virtue of computer programs running on respective computers and having a client-server relationship to each other. The server can be a cloud server, a server of a distributed system, or a server integrated with a blockchain.

It should be understood that the various forms of a flow shown above can be reordered, and a step can be added or deleted. For example, the steps described in the present application can be executed in parallel, sequentially, or in different orders, as long as the steps can achieve the desired results of the technical solutions disclosed in the present application, which is not limited herein.

The above specific embodiments do not constitute a limitation on the scope of protection of the present application. Those skilled in the art should understand that various modifications, combinations, sub-combinations and substitutions can be made according to a design requirement and other factors. Any modification, an equivalent substitution and an improvement made within the spirit and principles of the present application should be included within the scope of protection of the present application.

What is claimed is:

1. A method for generating audio based on large model, comprising:
obtaining a character that is generated in real time during a process of generating a text using a large model;
obtaining an audio feature of each audio unit of the character sequentially by using a pre-trained audio generation model based on the character; the audio feature of the audio unit is a discretized audio feature, and the character comprises audio features of a plurality of different audio units;
synthesizing a corresponding audio by using a pre-trained vocoder based on the audio feature of each audio unit.

2. The method according to claim 1, wherein the obtaining the audio feature of each audio unit of the character sequentially by using the pre-trained audio generation model based on the character comprises:
generating a pronunciation feature of the character by using a text encoder in the audio generation model based on the character;
obtaining the audio feature of each the audio unit of the character sequentially by using an audio unit generation model in the audio generation model based on the pronunciation feature of the character and in combination with a sound feature of a pronunciation object obtained in advance.

3. The method according to claim 2, wherein the generating the pronunciation feature of the character by using the text encoder in the audio generation model based on the character comprises:
generating the pronunciation feature of the character by using the text encoder based on the character in response to determining that a quantity of a character input in a first packet is greater than or equal to a predetermined quantity.

4. The method according to claim 2, wherein the obtaining the audio feature of each the audio unit of the character sequentially by using the audio unit generation model in the audio generation model based on the pronunciation feature of the character and in combination with the sound feature of the pronunciation object obtained in advance comprises:
generating a synthesized audio feature of the character by using an audio unit encoder in the audio unit generation model based on the pronunciation feature of the character and in combination with the sound feature of the pronunciation object;
obtaining the audio feature of each audio unit of the character sequentially by using an audio unit decoder in the audio unit generation model based on the synthesized audio feature of the character.

5. The method according to claim 4, wherein the obtaining the audio feature of each the audio unit of the character sequentially by using the audio unit decoder in the audio unit generation model based on the synthesized audio feature of the character comprises:
decoding an identifier of each audio unit of the character sequentially by using the audio unit decoder in the audio unit generation model based on the synthesized audio feature of the character;
obtaining a corresponding the audio feature of the audio unit based on the identifier of each audio unit and a pre-created audio unit database.

6. The method according to claim 2, wherein the pronunciation feature of the character comprises at least one of a phoneme, a prosody, and a pitch.

7. The method according to claim 1, wherein after obtaining the audio feature of each audio unit of the character sequentially by using the pre-trained audio generation model based on the character, the method further comprises:
generating a preset separator by using the audio generation model after generating the audio feature of the audio unit of the character.

8. The method according to claim 1, wherein synthesizing the corresponding audio by using the pre-trained vocoder based on the audio feature of each audio unit comprises:
synthesizing the corresponding audio by using the vocoder based on the audio feature of each the audio unit and in combination with a sound feature of a pronunciation object.

9. The method according to claim 2, wherein after obtaining the audio feature of each audio unit of the character sequentially by using the pre-trained audio generation model based on the character, the method further comprises:
generating a preset separator by using the audio generation model after generating the audio feature of the audio unit of the character.

10. The method according to claim 2, wherein synthesizing the corresponding audio by using the pre-trained vocoder based on the audio feature of each audio unit comprises:
synthesizing the corresponding audio by using the vocoder based on the audio feature of each the audio unit and in combination with a sound feature of a pronunciation object.

11. The method according to claim 3, wherein after obtaining the audio feature of each audio unit of the character sequentially by using the pre-trained audio generation model based on the character, the method further comprises:
generating a preset separator by using the audio generation model after generating the audio feature of the audio unit of the character.

12. An electronic device, comprising:
at least one processor; and
a memory communicatively connected with the at least one processor;
wherein the memory stores instructions executable by the at least one processor, and the instructions are executed by the at least one processor to enable the at least one processor to perform a method for generating audio based on large model, wherein the method for generating audio based on large model comprises:
obtaining a character that is generated in real time during a process of generating a text using a large model;
obtaining an audio feature of each audio unit of the character sequentially by using a pre-trained audio generation model based on the character; the audio feature of the audio unit is a discretized audio feature, and the character comprises audio features of a plurality of different audio units;
synthesizing a corresponding audio by using a pre-trained vocoder based on the audio feature of each audio unit.

13. The electronic device according to claim 12, wherein the obtaining the audio feature of each audio unit of the character sequentially by using the pre-trained audio generation model based on the character comprises:
generating a pronunciation feature of the character by using a text encoder in the audio generation model based on the character;
obtaining the audio feature of each the audio unit of the character sequentially by using an audio unit generation model in the audio generation model based on the pronunciation feature of the character and in combination with a sound feature of a pronunciation object obtained in advance.

14. The electronic device according to claim 13, wherein the generating the pronunciation feature of the character by using the text encoder in the audio generation model based on the character comprises:
generating the pronunciation feature of the character by using the text encoder based on the character in response to determining that a quantity of a character input in a first packet is greater than or equal to a predetermined quantity.

15. The electronic device according to claim 13, wherein the obtaining the audio feature of each the audio unit of the character sequentially by using the audio unit generation model in the audio generation model based on the pronunciation feature of the character and in combination with the sound feature of the pronunciation object obtained in advance comprises:
generating a synthesized audio feature of the character by using an audio unit encoder in the audio unit generation model based on the pronunciation feature of the character and in combination with the sound feature of the pronunciation object;
obtaining the audio feature of each audio unit of the character sequentially by using an audio unit decoder in the audio unit generation model based on the synthesized audio feature of the character.

16. The electronic device according to claim 15, wherein the obtaining the audio feature of each the audio unit of the character sequentially by using the audio unit decoder in the audio unit generation model based on the synthesized audio feature of the character comprises:
decoding an identifier of each audio unit of the character sequentially by using the audio unit decoder in the audio unit generation model based on the synthesized audio feature of the character;
obtaining a corresponding the audio feature of the audio unit based on the identifier of each audio unit and a pre-created audio unit database.

17. The electronic device according to claim 13, wherein the pronunciation feature of the character comprises at least one of a phoneme, a prosody, and a pitch.

18. The electronic device according to claim 12, wherein after obtaining the audio feature of each audio unit of the character sequentially by using the pre-trained audio generation model based on the character, the method further comprises:
generating a preset separator by using the audio generation model after generating the audio feature of the audio unit of the character.

19. The electronic device according to claim 12, wherein synthesizing the corresponding audio by using the pre-trained vocoder based on the audio feature of each audio unit comprises:
synthesizing the corresponding audio by using the vocoder based on the audio feature of each the audio unit and in combination with a sound feature of a pronunciation object.

20. A non-transitory computer readable storage medium with computer instructions stored thereon, wherein the computer instructions are used for causing a method for generating audio based on large model, wherein the method for generating audio based on large model comprises:
obtaining a character that is generated in real time during a process of generating a text using a large model;
obtaining an audio feature of each audio unit of the character sequentially by using a pre-trained audio generation model based on the character; the audio feature of the audio unit is a discretized audio feature, and the character comprises audio features of a plurality of different audio units;
synthesizing a corresponding audio by using a pre-trained vocoder based on the audio feature of each audio unit.
